(19) United States
(12) Patent Application Publication
(10) Pub. No.: US 2010/0315360 A1
(43) Pub. Date: Dec. 16, 2010

(54) MULTI-TOUCH INPUT DEVICE

(75) Inventor: CHUN-YU LEE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/754,590

(22) Filed: Apr. 5, 2010

(30) Foreign Application Priority Data
Jun. 10, 2009 (CN) 200910303119.5

(51) Int. Cl. G06F 3/041

(52) U.S. Cl. 345/173

(57) ABSTRACT

An exemplary multi-touch input device includes a stress sensing plate, a first polarizer, a infrared light module, a second polarizer, an infrared camera module, and a processor. The stress sensing plate has a touching surface, an internal stress is generated when an object touches the tress sensing plate. The infrared light source module is configured for emitting infrared light to the first polarizer. The first polarizer is disposed between the stress sensing plate and the infrared light source. The infrared camera module is configured for capturing the image corresponding to the infrared light outputting from the stress sensing plate through the second polarizer. The processor is to receive the infrared image from the infrared camera module and obtain the position or a trace the stress sensing plate be touched accordingly.

### BACKGROUND

1. Technical Field

The present disclosure relates to an input device and, particularly to a multi-touch input device.

2. Description of Related Art

With the rapid development of science and technology, electronic devices with touch panels, such as notebook computers, personal digital assistants (PDAs), mobile phones, global positioning systems (GPSs) and multimedia players, are now widely used in many people's lives. In current days, touch panels include resistive touch panels and capacitive touch panels. However, in these touch panels, detecting circuit is arranged on the panel, these touch panels can not be applied in multi-touch.

Therefore, a multi-touch input device which can overcome the above mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is a cross-sectional schematic view of a multi-touch input device according to a first embodiment of the present disclosure.

FIG. 2 is a top plan view of the multi-touch input device of FIG. 1.

FIG. 3 is a cross-sectional schematic view of a multi-touch input device according to a second embodiment of the present disclosure.

FIG. 4 is a top plan view of the multi-touch input device of FIG. 3.

FIG. 5 is a cross-sectional schematic view of a multi-touch input device according to a third embodiment of the present disclosure.

FIG. 6 is a top plan view of the multi-touch input device of FIG. 5.

### DETAILED DESCRIPTION

Various embodiments will now be described in detail below with reference to the drawings.

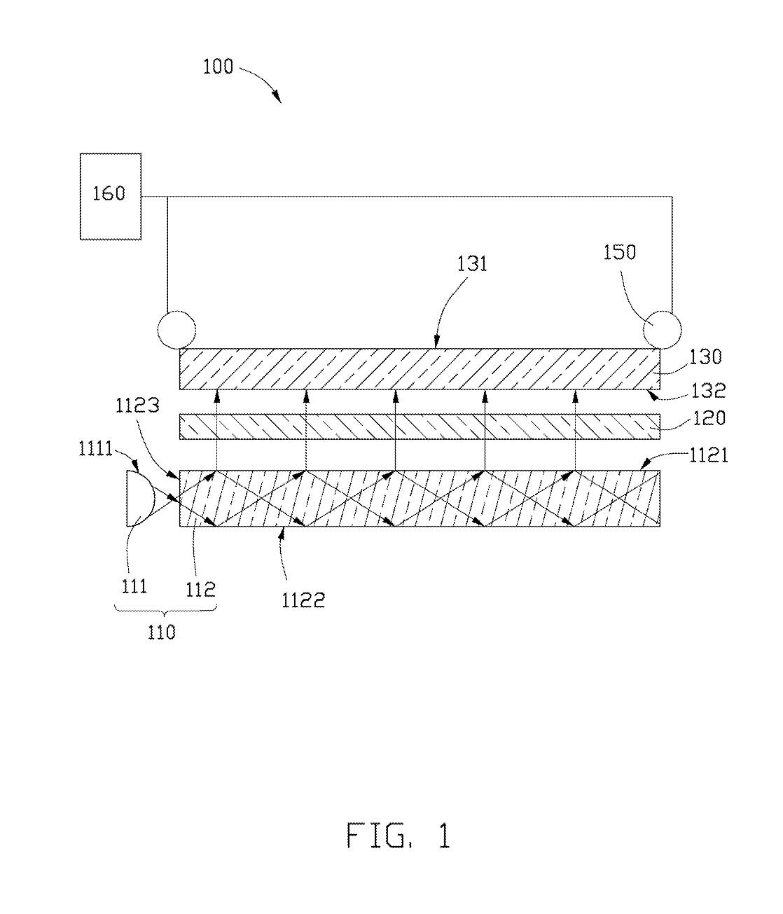

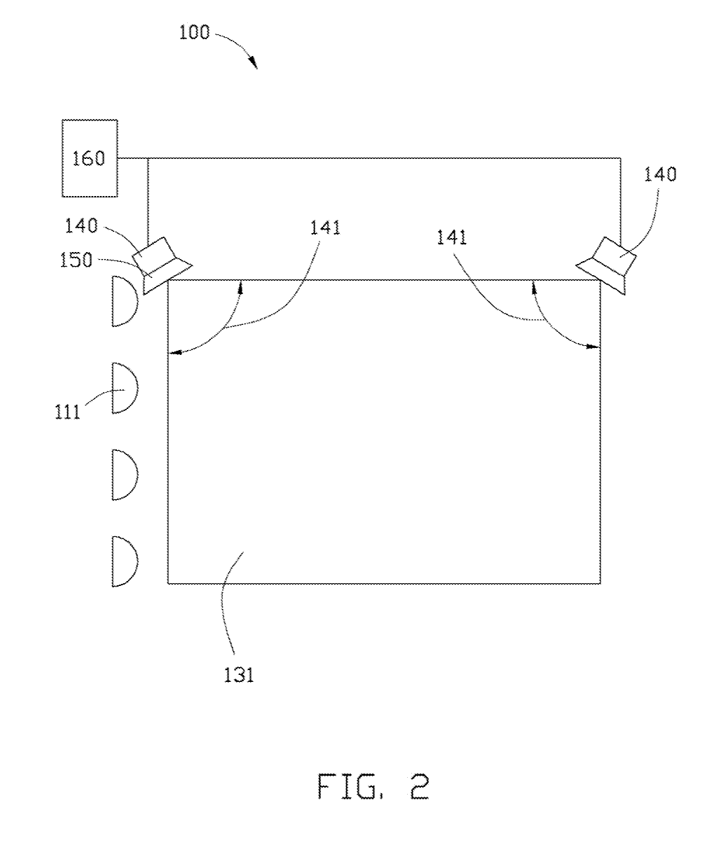

Referring to FIGS. 1 and 2, a multi-touch input device 100 according to a first embodiment is shown. The multi-touch input device 100 includes an infrared light source module 110, a first polarizer 120, a stress sensing plate 130, two infrared camera modules 140, two second polarizers 150, and a processor 160.

The infrared light source module 110 is configured for emitting infrared light to the first polarizer 120. In the present embodiment, the infrared light source module 110 includes four infrared light sources 111 and a light guide plate 112. The light guide plate 112 has a rectangular cross section. The light guide plate 112 includes a light emitting surface 1121 facing the first polarizer 120, a side surface 1123 adjacent to the light emitting surface 1121, and a bottom surface 1122 at an opposite side thereof to the light emitting surface 1121. The bottom surface 1122 can have a plurality of pattern dots (not shown) defined thereon. The pattern dots are used for diffusing the infrared light in the light guide plate 112 to make the infrared light be uniformly emitted out via the light emitting surface 1121. The four infrared light sources 111 are arranged in a line parallel to the side surface 1123. Each infrared light source 111 has a light emitting surface 1111. The light emitting surfaces 1111 of the four infrared light sources 111 face the side surface 1123. The infrared light sources 111 can be infrared LEDs or infrared lasers. Light beams from the infrared light sources 111 can pass through the side surface 1123 and enter the light guide plate 112. Then the light beams can be reflected and refracted in the light guide plate 120, and finally be output from the light emitting surface 1121. It can be understood that the number of the infrared light sources 111 is not limited to the present embodiment, and the shape of the light guide plate 112 can either be cylinder or prism.

The first polarizer 120 is configured for transmitting light with a first polarization direction and blocking light with other polarization directions. In other words, the first polarizer 120 has a transmission axis, and light with a polarization direction which is parallel to the transmission axis can only transmit therefrom. That is, the first polarization direction is parallel to the transmission axis of the polarizer 120. The first polarizer 120 is disposed between the light guide plate 112 and the stress sensing plate 130. The first polarizer 120 faces the light emitting surface 1121. The first polarizer 120 is a linear polarizer. The first polarizer 120 is a plate and has a rectangular cross section. In the illustrated embodiment, the first polarizer 120 is parallel with the light emitting surface 1121.

The stress sensing plate 130 is positioned on a side of the first polarizer 120 far away from the infrared light module 110. The stress sensing plate 130 has a rectangular cross section. The stress sensing plate 130 has a touching surface 131 and a back surface 132 at an opposite side thereof to the touching surface 131. The back surface 132 faces the first polarizer 120. A material of the stress sensing plate 130 is light pervious, and has a character that an internal stress will emerge when the stress sensing plate 130 is being touched. The material of the sensing plate 130 can either be plastic or liquid crystal. When an object touches the touching surface 131, a force acts on the stress sensing plate 130, an internal stress emerges in the touched portion of the stress sensing plate 130. Due to stress sensing plate 130 having anisotropy property, a birefringence is taken place when light beams pass through the touched portion of the stress sensing plate 130. In other words, an optical path difference between an ordinary ray and an extraordinary ray of a light beam passed through the touched portion is not zero, and the optical path difference between an ordinary ray and an extraordinary ray is in accordance to the distribution of the internal stress in the portion of the stress sensing plate 130. When the stress sensing plate 130 is positioned between two polarizers having transmission axes perpendicular to each other, interference fringes will be observed from either of the two polarizers. A portion where internal stresses distribute more densely, the distribution of the interference fringes will be denser.

Since the infrared light emitted from the infrared light source 111 is in the infrared portion of the light spectrum, it does not conflict with any image displayed in the visible portion of the light spectrum.

Two infrared camera modules 140 are disposed above the touching surface 131. In the illustrated embodiment, the two infrared camera modules 140 are located above two corners of the touching surface 131, such as at the upper left corner and at the upper right corner, as shown in FIG. 2.

In the present embodiment, each infrared camera module 140 has a field of view 141, which is in a range from about 90 to about 120 degrees. Thus the entire touching surface 131 is covered by the overlapping fields of view 141 of the two infrared camera modules 140. Each infrared camera module 140 can be considered to be capable of capturing an infrared image representing a single (horizontal) slice of the infrared light that emits from the touching surface 131. It will be understood that the number of the infrared camera modules 140 can be more than two, depending on the size of the touching surface 131 and the field of view 141 of each infrared camera module 140.

The second polarizers 150 are arranged between the touching surface 131 and the infrared camera modules 140. The infrared camera modules 140 capture images of interference fringes, which are generated in the stress sensing plate 130 when it is pressed due to the birefringence for light beams. A polarization direction of the second polarizer 150 is perpendicular to that of the first polarizer 130. In other words, each second polarizer 150 has a transmission axis, and light with a polarization direction which is parallel to the transmission axis can only transmit therefrom. That is, the second polarization direction is parallel to the transmission axis of the second polarizer 150. In the present embodiment, each second polarizer 150 is disposed on the object side of one infrared camera module 140. A polarization direction of the second polarizer 150 is perpendicular to that of the first polarizer 130. It can be understood that the second polarizers 150 can be disposed in the infrared camera modules 140.

The processor 160 is electrically connected to the two infrared camera modules 140. The processor 160 is configured for receiving the images captured by the infrared camera modules 140 and analyzing the images to obtain a position or a trace the stress sensing plate being touched.

Infrared light emitted from the infrared light source 111 can enter the light guide plate 112 from the side surface 1123, output from the light emitting surface 1121 and then propagate to the first polarizer 120. Light beams transmit from the first polarizer 120 have a first polarization direction, and can enter into the stress sensing plate 130. When no object touches the touching surface 131 of the stress sensing plate 130, no internal stress is generated in the stress sensing plate 130. The infrared light beams with a first polarization direction pass through the stress sensing plate 130, no birefringence takes place, and accordingly the infrared camera modules 140 can not capture images of interference fringes. When an object touches and presses the touching surface 131, internal stresses are generated in the stress sensing plate 130. The infrared light beams with a first polarization direction pass through the stress sensing plate 130, the birefringence is taken place, and the infrared camera modules 140 can capture images of interference fringes. Then the processor 160 can receive the images from the infrared camera modules 140 and analyze the particular portion of the touching surface 131 being touched and pressed. It can be understood, when several portions of the touching surface being touched simultaneously, the infrared camera modules 140 can capture a number of images of interference fringes, and the processor 160 can receive and analyze the images from the infrared camera modules 140. Finally several particular portions of the touching surface 131 being touched also can be obtained. It also can be understood, when an object touches the touching surface 131 and moves on the touching surface, the processor 160 can obtain the particular trace of the touching surface 131 being touched and pressed.

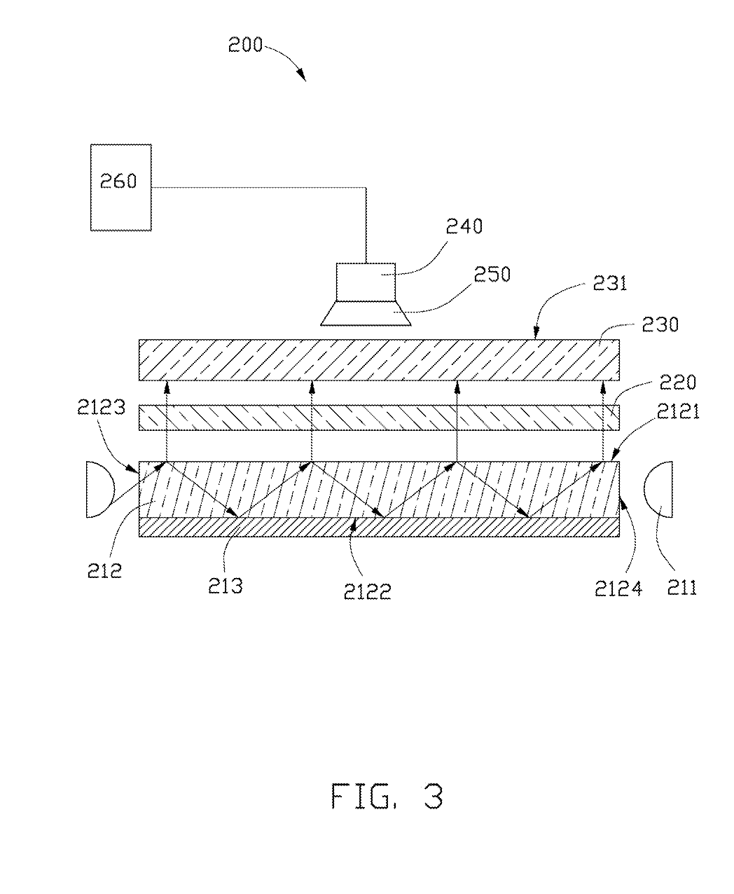

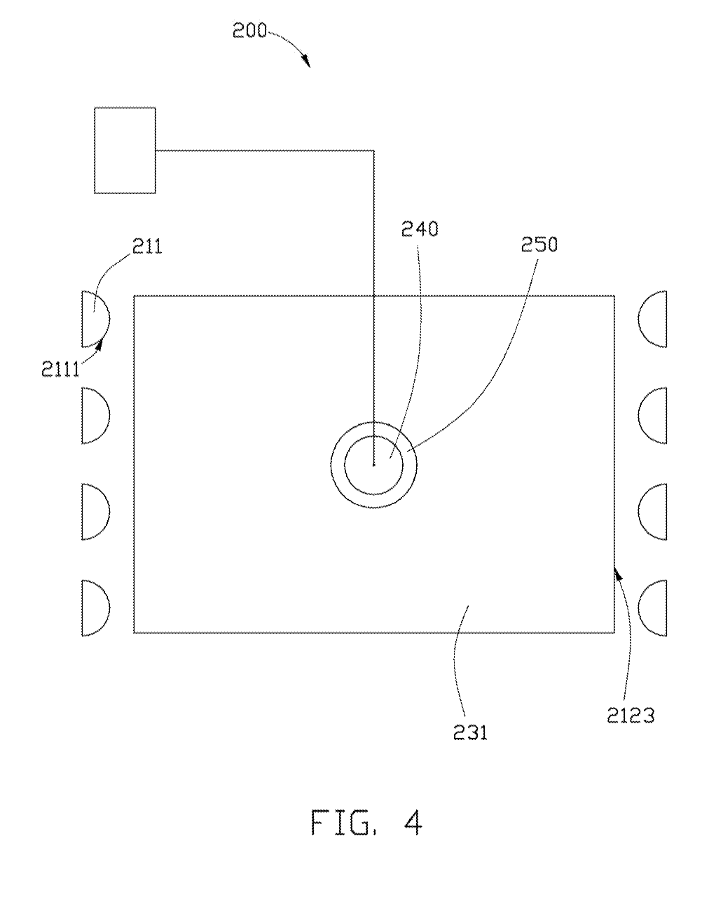

Referring to FIGS. 3 and 4, a multi-touch input device 200 according to a second embodiment is shown. The multi-touch input device 200 is similar to the multi-touch input device 100 of the first embodiment. The multi-touch input device 200 includes an infrared light source module 210, a first polarizer 220, a stress sensing plate 230, an infrared camera module 240, a second polarizer 250, and a processor 260.

The infrared light source module 210 includes eight infrared light sources 211, a light guide plate 212, and a reflective sheet 213. The light guide plate 212 has a rectangular cross section. The light guide plate 212 includes a light emitting surface 2121 facing the first polarizer 220, a first side surface 2123 adjacent to the light emitting surface 2121, a second side surface 2124 at an opposite side thereof to the first side surface 2123, and a bottom surface 2122 at an opposite side thereof to the light emitting surface 2121. Each infrared light source 211 has a light emitting surface 2111. Four infrared light sources 211 are arranged in a line parallel with the first side surface 2123 in such a manner that the light emitting surfaces 2111 thereof face the side first surface 2123. The other four infrared light sources 211 are arranged in a line parallel with the second side surface 2124 in such a manner that the light emitting surfaces 2111 thereof face the side second surface 2124.

The reflective sheet 213 is attached on the bottom surface 2122. The reflective sheet 213 can reflect the light and avoid the light emitting from the bottom surface 2122. Thus the utilization rate of the infrared light emitted from the infrared light sources 211 is increased.

The arrangement of the first polarizer 220 and the stress sensing plate 230 are similar to that of the first embodiment. The first polarizer 220 is disposed between the light guide plate 212 and the stress sensing plate 230. The first polarizer 220 faces the light emitting surface 2121. The stress sensing plate 230 is positioned on a side of the first polarizer 220 far away from the infrared light module 210. The stress sensing plate 230 has a touching surface 231 on a side of the stress sensing plate 230 far away from the first polarizer 220.

The infrared camera module 240 can be considered to be capable of capturing an infrared image representing the infrared light that emits from the top of the touching surface 231. In the illustrated embodiment, the infrared camera module 240 is positioned above a center portion of the touching surface 231. The field of view of the infrared camera module 240 can cover the entire touching surface 231. It can be understood that in alternative embodiments, the infrared camera module 240 can be arranged in another appropriate position if the field of view of the infrared camera module 240 can cover the entire touching surface 231

The second polarizer 250 are positioned between the touching surface 231 and the infrared camera modules 240. The processor 260 is electrically connected to the infrared camera module 240. The processor 260 is configured for receiving the images captured by the infrared camera module 240 and dealing with the image to obtain a position or a trace the stress sensing plate being touched.

Infrared light emitted from the infrared light source 211 can input the light guide plate 212 from the side surface 2123, 2124, output from the light emitting surface 2121, and then propagate to the first polarizer 220. Light beams transmit from the first polarizer 220 have a first polarization direction, and can enter into the stress sensing plate 230. Light beams transmit from the first polarizer 220 have a first polarization direction, and can enter into the stress sensing plate 230. When no object touches the touching surface 231 of the stress sensing plate 230, no internal stress is generated in the stress sensing plate 230. The infrared light beams with a first polarization direction pass through the stress sensing plate 230, no birefringence takes place, and accordingly the infrared camera modules 240 can not capture images of interference fringes. When an object touches and presses the touching surface 231, internal stresses are generated in the stress sensing plate 230. The infrared light beams with a first polarization direction pass through the stress sensing plate 230, the birefringence is taken place, and the infrared camera modules 240 can capture images of interference fringes. Then the processor 260 can receive the images from the infrared camera modules 240 and analyze the particular portion of the touching surface 231 being touched and pressed. It can be understood, when several portions of the touching surface being touched simultaneously, the infrared camera modules 240 can capture a number of images of interference fringes, and the processor 260 can receive and analyze the images from the infrared camera modules 240. Finally several particular portions of the touching surface 231 being touched also can be obtained. It also can be understood, when an object touches the touching surface 231 and moves on the touching surface, the processor 260 can obtain the particular trace of the touching surface 231 being touched and pressed.

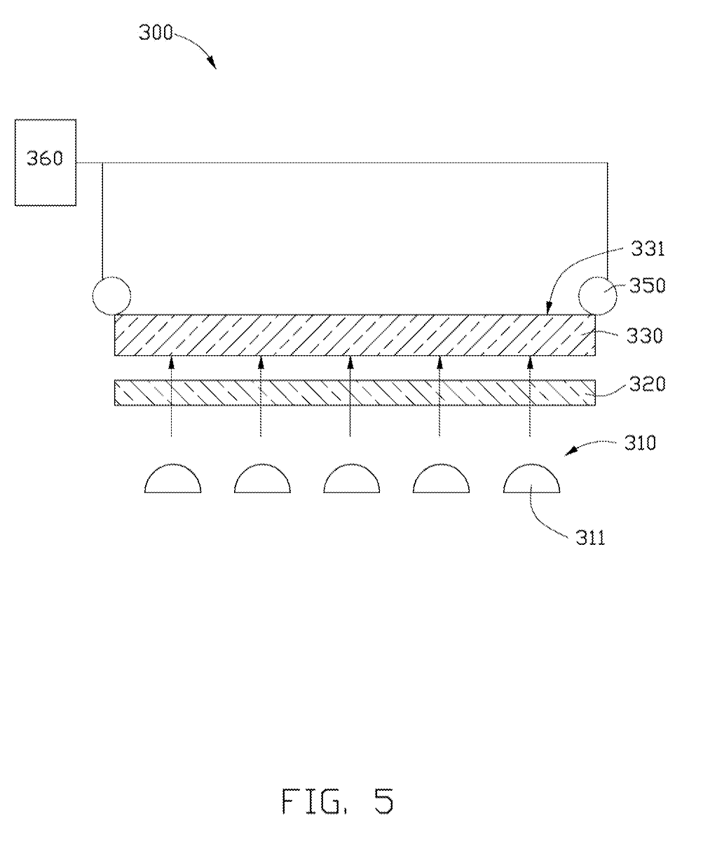

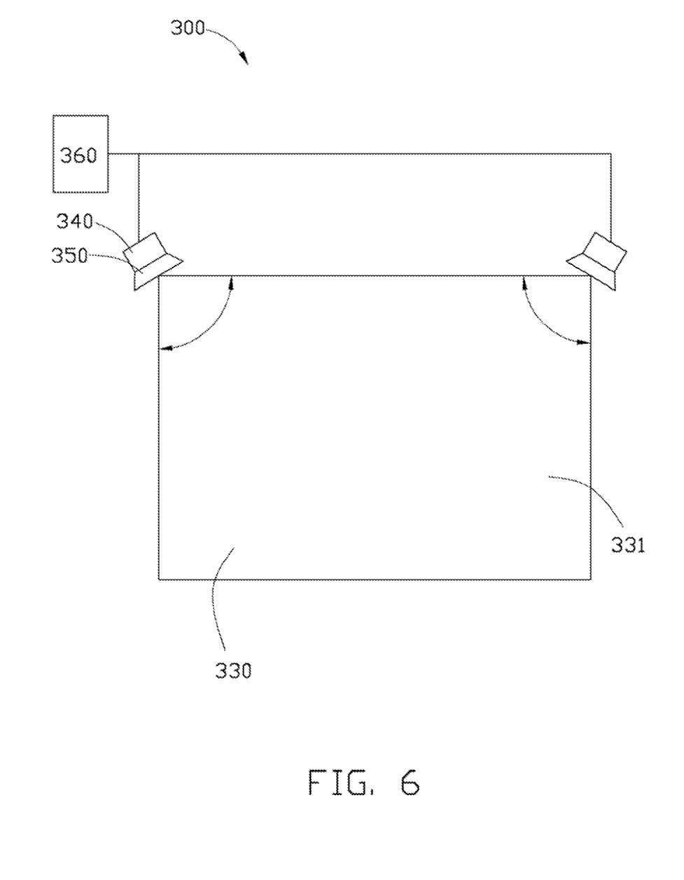

Referring to FIGS. 5 and 6, a multi-touch input device 300 according to a third embodiment is shown. The multi-touch input device 300 is similar to the multi-touch input device 100. The multi-touch input device 300 includes an infrared light source module 310, a first polarizer 320, a stress sensing plate 330, two infrared camera modules 340, two second polarizer 350, and a processor 360.

The infrared light module 310 includes a plurality of infrared light sources 311 arranged in an array below the first polarizer 320. Each of the infrared light sources 311 faces the first polarizer 320. The infrared light emitted from the infrared light sources 311 can enter the first polarizer 320 directly.

A arrangement of the first polarizer 320, the stress sensing plate 330, the infrared camera modules 340, the second polarizer 350, and the processor 360 is similar to the first embodiment. The first polarizer 120 is disposed between the light module 310 and the stress sensing plate 330. The stress sensing plate 330 is positioned on a side of the first polarizer 320 far away from the infrared light module 310. The stress sensing plate 330 has a touching surface 331 on a side of the stress sensing plate 330 far away from the first polarizer 320. Two infrared camera modules 340 are disposed above the touching surface 331. In the present embodiment, the two infrared camera modules 340 are located above two corners of the touching surface 331. The second polarizers 350 are positioned between the touching surface 331 and the infrared camera modules 340. The processor 360 is electrically connected to the infrared camera modules 340. The processor 360 is configured for receiving the images captured by the infrared camera modules 340 and dealing with the image to obtain a position or a trace the stress sensing plate 330 being touched.

Infrared light emitted from the infrared light sources 311 can enter the first polarizer 320, and then propagate to the first polarizer 320. Light beams transmit from the first polarizer 320 have a first polarization direction, and can enter into the stress sensing plate 330. When no object touches the touching surface 331 of the stress sensing plate 330, no internal stress is generated in the stress sensing plate 330. The infrared light beams with a first polarization direction pass through the stress sensing plate 330, no birefringence takes place, and accordingly the infrared camera modules 340 can not capture images of interference fringes. When an object touches and presses the touching surface 331, internal stresses are generated in the stress sensing plate 330. The infrared light beams with a first polarization direction pass through the stress sensing plate 330, the birefringence is taken place, and the infrared camera modules 340 can capture images of interference fringes. Then the processor 360 can receive the images from the infrared camera modules 340 and analyze the particular portion of the touching surface 331 being touched and pressed. It can be understood, when several portions of the touching surface being touched simultaneously, the infrared camera modules 340 can capture a number of images of interference fringes, and the processor 360 can receive and analyze the images from the infrared camera modules 340. Finally several particular portions of the touching surface 331 being touched also can be obtained. It also can be understood, when an object touches the touching surface 331 and moves on the touching surface, the processor 360 can obtain the particular trace of the touching surface 331 being touched and pressed.

While certain embodiments have been described and exemplified above, various other embodiments from the foregoing disclosure will be apparent to those skilled in the art. The present disclosure is not limited to the particular embodiments described and exemplified but is capable of considerable variation and modification without departure from the scope and spirit of the appended claims.

1. A multi-touch input device, comprising:
a stress sensing plate comprising a touching surface and a back surface at an opposite side thereof to the touching surface, the stress sensing plate being configured for generating an internal stress in a portion which is being pressed by touching the touching surface so as to induce birefringence for light beams;
an infrared light module configured for emitting infrared light to the back surface;
a first polarizer arranged between the back surface and the infrared light source module, the first polarizer having a first transmission axis;
a second polarizer having a second transmission axis which is perpendicular to the first transmission axis;
at least one infrared camera module adjacent to the touching surface, the second polarizer being arranged between the at least one infrared camera module and the touching surface, the at least one infrared camera module being configured for capturing images of interference fringes, which are generated in the stress sensing plate when it is pressed due to the birefringence for light beams; and
a processor electrically communicating with the at least one infrared camera module, the processor being configured for receiving and analyzing the captured images to obtain the touched position of the touching surface.

2. The multi-touch input device of claim 1, wherein a material of the sensing plate is liquid crystal.

3. The multi-touch input device of claim 1, wherein a material of the sensing plate is plastic.

4. The multi-touch input device of claim 1, wherein the infrared light module comprises at least one infrared light source and a light guide plate, the light guide plate has a light emitting surface facing the first polarizer and at least one side surface adjacent to the infrared light source, the at least one infrared light source is configured for emitting light beams to the at least one side surface, and the light guide plate is configured for outputting light beams from the light emitting surface.

5. The multi-touch input device of claim 4, wherein the light guide plate further comprises a bottom surface at the opposite side thereof to the light emitting surface, and the infrared light module further comprises a reflective sheet attached on the bottom surface.

6. The multi-touch input device of claim 1, wherein the at least one infrared camera module is one infrared camera module which is disposed above a central portion of the touching surface.

7. The multi-touch input device of claim 1, wherein a field of view of the at least one infrared camera module covers the entire touching surface.

8. The multi-touch input device of claim 1, wherein the infrared light module comprises an array of infrared light sources, which is configured for emitting infrared light beams to the first polarizer directly.

9. The multi-touch input device of claim 1, wherein the at least one infrared camera modules comprises two infrared camera modules, the two infrared camera modules are disposed above two corner portion of the touching surface.

10. The multi-touch input device of claim 9, wherein the fields of view of the two infrared camera modules cooperatively cover the entire touching surface.
